(19) United States
(12) Patent Application Publication
(10) Pub. No.: US 2005/0174344 A1
(43) Pub. Date: Aug. 11, 2005

(54) Active matrix display device

(76) Inventor: Kwang-Hyun La, Kyungki-do (KR)

Correspondence Address: CANTOR COLBURN, LLP, 55 GRIFFIN ROAD SOUTH, BLOOMFIELD, CT, 06002, US

(21) Appl. No.: 10/505,059

(22) PCT Filed: Dec. 24, 2002
(86) PCT No.: PCT/KR02/02432

(30) Foreign Application Priority Data
Jul. 22, 2002 (KR) 10-2002-0042934

(51) Int. Cl. G09G 5/00

(52) U.S. Cl. 345/208

(57) ABSTRACT

In an active matrix display device, gate signals are delayed or distorted as they go to the right due to load of the gate lines and parasitic capacitances of the gate lines and pixels. TP signals for respective blocks of data lines are supplied with time difference such that data signals are applied to the respective blocks of the data lines not in synchronous manner but in a staggered manner. The time difference in the application of the data signals between the data lines is substantially equal to the delay of the gate signals, thereby solving the non-uniform charging of the data signals in the pixels.

### BACKGROUND OF THE INVENTION

(a) Field of the Invention

The present invention relates to an active matrix display device.

(b) Description of the Related Art

A plurality of display devices such as a liquid crystal display (LCD), a field emission display (FED), a electrolumniesecent (EL) display device, a plasma display panel (PDP) are driven in active matrix type.

The active matrix display devices are driven by applying gate signals for turning on and off driving transistors in pixels arranged in a matrix though gate lines. When the gate signals are transmitted from a gate driver located at a left side of a display panel, the gate signals are much delayed and distorted due to load of the gate lines and parasitic capacitances between the gate lines and the pixels as they go to the right.

The signal delay or distortion of the gate signals at the right side delays the activation of the driving transistors of the pixels at the right side compared with the driving transistors of the pixels at the left side. Consequently, the charging time of data signals for the righter pixels become shorter such that the charging of the data signals for the pixels at the left and right sides are not uniform since the data signals for all the pixels are simultaneously applied to data lines. In addition, the delayed gate signals may make the driving transistors of the light pixels still activated when the data signals for the next row are applied.

Particularly in an LCD subject to an inversion driving, a shading generated by the inverted data voltages for the next row may cause severe horizontal stripes. The width of gate masking may be enlarged for such a shading margin.

### SUMMARY OF THE INVENTION

A motivation of the present invention is to solve the non-uniform charging of the data voltages due to the delay of the gate signals.

In order to solve the motivation, the present invention applies data signals to data lines in a staggered manner.

A display panel according to a first aspect of the present invention includes a plurality of data lines extending parallel to each other in a column direction and a plurality of gate lines extending parallel to each other in a row direction. A plurality of pixels receiving gate signals and data signals respectively from the gate lines and the data lines to display images, each pixel including a switching element transmitting the data signals in response to the gate signals are arranged in a matrix. Each pixel includes a switching element transmitting the data signals in response to the gate signals. A gate driver supplies the gate signals to the gate lines, and a data driver supplies the data signals to the data lines in synchronization with a plurality of first control signals. The data lines are grouped into a plurality of blocks, each block including at least one of the data lines and the first control signals correspond to the respective blocks and have different tiring.

The display device according to the first aspect of the present invention may further include a signal controller outputting a timing signal for driving the display panel and a second control signal, and a control signal shifting unit receiving the second control signal and shifting the second control signal in sequence to generating the first control signals.

Preferably, the control signal shifting unit includes a plurality of shifters for sequentially shifting the second control signal to be transmitted to adjacent shifters and the first control signals includes the second control signal and outputs of the shifters.

The display device according to the first aspect of the present invention may further include a signal controller outputting a timing signal for driving the display panel and a second control signal.

A display device according to a second aspect of the present invention includes a signal controller outputting a gate control signal for controlling the gate signals and a second control signal for controlling the data signals, respectively. A gate driver supplies the gate signals to the gate lines in synchronization with the gate control signal from the signal controller, and a control signal shifting unit shifts the second control signal in sequence to generating a plurality of first control signals having timing differences. The data lines are grouped into a plurality of blocks corresponding to the first control signals and a data driver supplies the data signals to the blocks in synchronization with the first control signals from the control signal shifting unit.

The display device may further include a control signal shifting unit including a plurality of shifters sequentially shifting the second control signal to be transmitted adjacent one of the shifters to generate a plurality of first control signals.

A display device according to a third aspect of the present invention includes a signal controller outputting a gate control signal for controlling timing of the gate signals and a plurality of first control signals for controlling timing of the data signals, the second control signals having timing differences. A gate driver supplies the gate signals to the gate lines in synchronization with the gate control signal. The data lines are grouped into a plurality of blocks corresponding to the first control signals from the signal controller and a data driver supplies the data signals to the blocks in synchronization with the first control signals.

In the display devices according to the first to the third aspects of the present invention, at least one of the timing differences between the first control signals is preferably different from another of the timing differences.

### BRIEF DESCRIPTION OF THE DRAWINGS

FIG. 1 is a schematic block diagram of an active matrix display device according to the first embodiment of the present invention;

FIG. 2 shows gate signals for pixels in a row;

FIG. 3 is a block diagram of a TP signal shifting unit according to the first embodiment of the present invention;

FIG. 4 illustrates TP signals generated by a TP signal shifting limit according to the first embodiment of the present invention;

FIG. 5 shows data signals applied to data lines according to the first embodiment of the present invention; and

FIG. 6 is a schematic block diagram of an active matrix display device according to a second embodiment of the present invention.

### DETAILED DESCRIPTION OF THE PREFERRED EMBODIMENTS

The present invention now will be described in more detail hereinafter with reference to the accompanying drawings, in which preferred embodiments of the invention are shown. However, thus invention may be embodied in many different forms and should not be construed as limited to the embodiments set forth herein. Like numerals refer to like elements throughout.

Then, active matrix display devices according to embodiments of the present invention will be described in detail with reference to accompanying drawings.

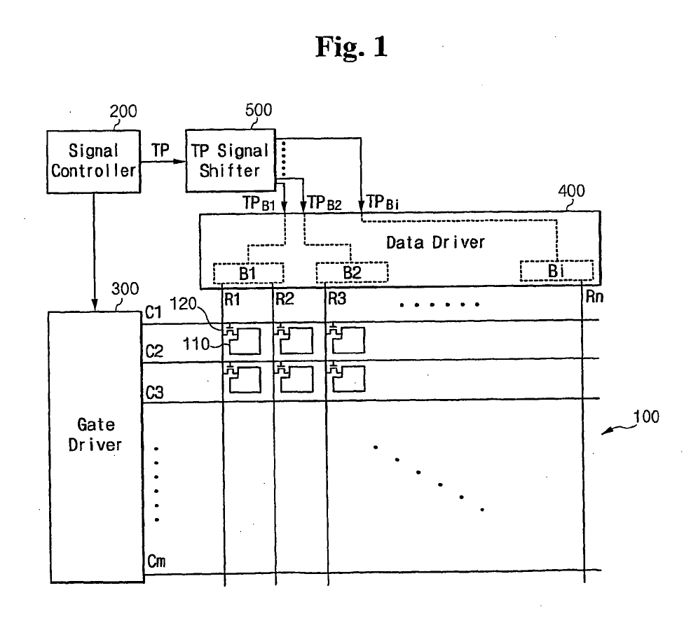

Referring to FIGS. 1-5, an active matrix display device according to the first embodiment of the present invention is described.

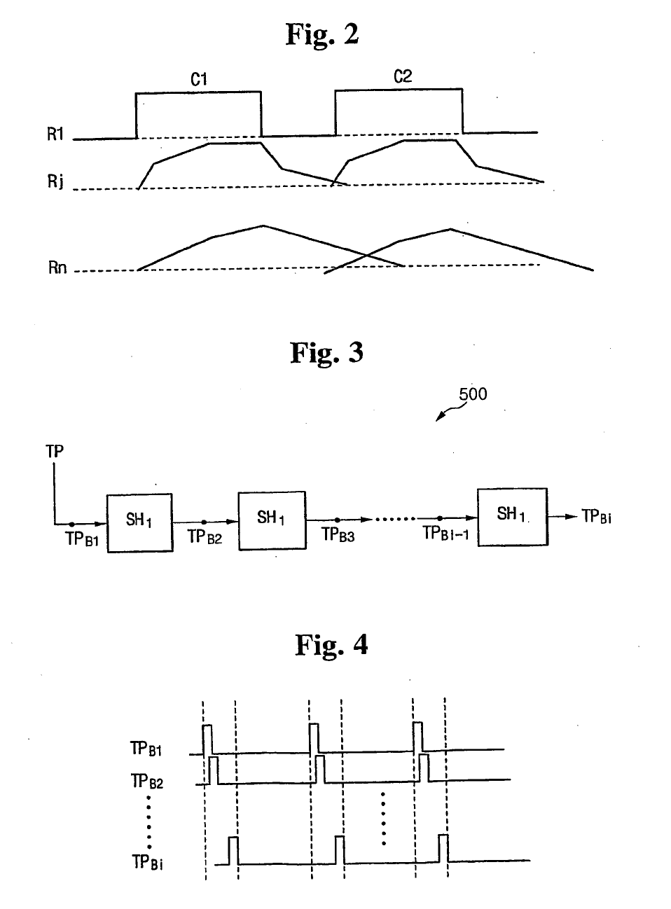

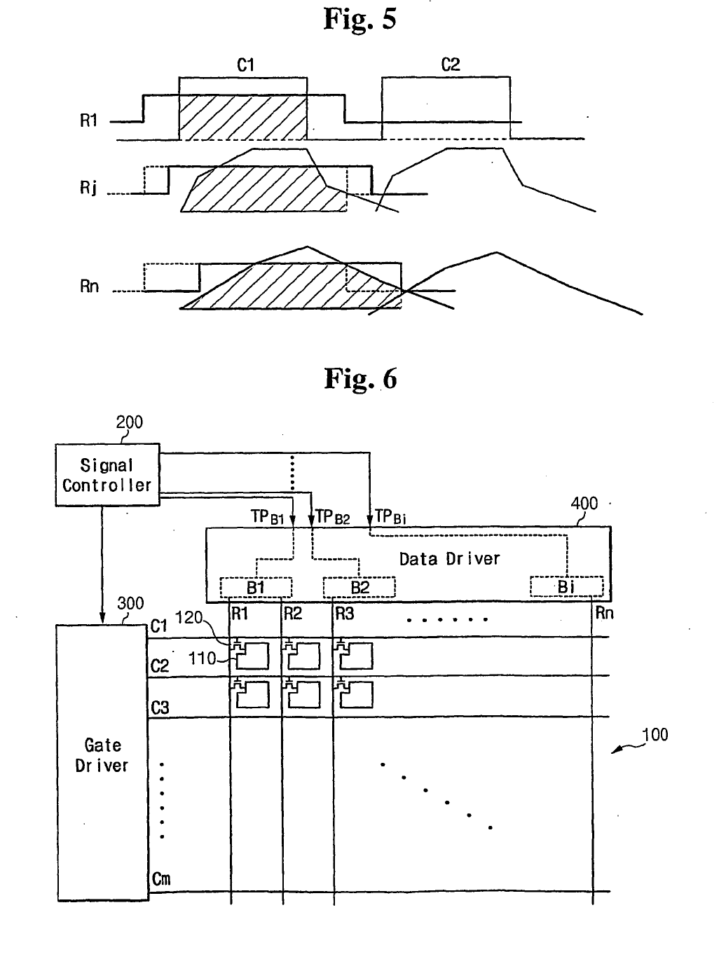

FIG. 1 is a schematic block diagram of an active matrix display device according to the first embodiment of the present invention and FIG. 2 shows gate signals for pixels in a row. FIG. 3 is a block diagram of a TP signal shifting unit according to the first embodiment of the present invention and FIG. 4 illustrates TP signals generated by a TP signal shifting unit according to the first embodiment of the present invention. FIG. 5 shows data signals applied to data lines according to the first embodiment of the present invention.

Referring to FIG. 1, a display device according to a first embodiment of the present invention includes a display panel 100, a signal controller 200, a gate driver 300, a data driver 400, and a TP signal shifting unit 500. The display panel 100 includes a plurality of gate lines C1-Cm extending in a transverse direction and a plurality of data lines R1-Rn extending in a longitudinal direction, which are formed thereon. Two adjacent gate lines and two adjacent data lines define a pixel area, and a transistor 120 for transmitting data signals from a data line to a pixel 110 in response to gate signals from a gate line are provided in each pixel area. The pixel 110 is charged with the data signals to display images.

The signal controller 200 receives a vertical synchronization signal Vsync for distinguishing frames, a horizontal synchronization signal Hsync for distinguishing rows, and a clock signal MCLK from an external graphics controller (not shown). The signal controller 200 generates control signals and a TP signal for driving the gate driver 300 and the data driver 400 based on the received signals to be provided for the gate driver 300 and the data driver 400.

The gate driver 300 sequentially applies the gate signals for turning on the transistors 120 to the gate lines C1-Cm in response to the control signals from the signal controller 200. In case that the gate driver 300 applying the gate signals to the gate lines C1-Cm is located at a left side of the display panel 100, as shown in FIG. 2, the gate signals may become delayed and distorted due to load of the gate lines C1-Cm and parasitic capacitances generated between the gate liens C1-Cm and the pixels 110 as they go to the right.

The data driver 400 applies the data signals to the pixels 110 through the data lines R1-Rn based on a triggered pulse signal (referred to as “a TP signals” hereinafter) from the signal controller 200. The first embodiment of the present invention groups the data lines R1-Rn into i (where 2≦i≦n) blocks B1-Bi and supplies TP signals for the respective blocks B1-Bi in a staggered manner. Each block may include one data line or several data lines. The numbers of the data lines R1-Rn in the blocks B1-Bi are equal or different. The time differences in the TP signals between successive blocks are equal or different depending on the delay and the distortion, and they are preferably determined depending on the delay and the distortion of the gate lines C1-Cm.

The TP signal shifting unit 500 of the display device according to the first embodiment of the present invention gives time differences to the TP signal from the signal controller 200 and transmits the asynchronous differentiated TAP signals TP_{B1}-TP_{Bi} to the data driver 300. The TP signal shifting unit 500 is located between the signal controller 200 and the data driver 400 or incorporated in the signal controller 200.

An exemplary TP signal shifting unit 500 according to the first embodiment of the present invention is described in detail with reference to FIGS. 3-5.

As shown in FIG. 3, a TP signal shifting limit 500 includes (i-1) shifters SH₁-SHᵢ₋₁ connected in sequence and receives a TP signal TP_{B1} shown in FIG. 4. The shifter SH₁ shifts TP signal TP_{B1} inputted into the TP signal shifting unit 500 are shifted by a predetermined clock and transmits the shifted TP signal TP_{B2} to an adjacent shifter SH₂. Likewise, the shifters SH₂-SHᵢ₋₁, shifts the TP signals TP_{B2}-TP_{Bi-1} shifted by the previous shifters SH₁-SHᵢ₋₂ to generate the shifted TP signals TP_{B3}-TP_{Bi}.

Then, the TP signal TP_{B1} inputted to the TP signal shifting unit 500 and the TP signals TP_{B2}-TP_{Bi} outputted by the shifters SH₁-SHᵢ₋₁ function as the TP signals for the respective blocks B1-Bi. At this time, the number of clocks shifted by each shifter SH₁-SHᵢ₋₁ is preferably determined in consideration of the delay of the gate signals for the corresponding block B1-Bi and it is also preferably determined enough to secure a blanking period without application of the data voltages.

The shift of the TP signal to be supplied to the data driver 400 differentiates the application time of the data signals to the data lines R1-Rn in the blocks B1-Bi. Since the time difference in the application of the data signals between the data lines R1, . . . , Rj, . . . , Rn is substantially equal to the delay of the gate signals as shown in FIG. 5, the charging CH1, . . . , CHj, . . . , CHn of the data signals in the pixels 110 become substantially uniform. This prevents a shading generated by the delayed gate signals and the data signals for a next row, thereby reducing shading margins to optimize a gate masking width.

The first embodiment of the present invention shifts the TP signal from the signals controller 200 by employing the shifters to give time difference to the data signals for the blocks. However, the signal controller 200 can generate separate TP signals for the respective blocks without providing independent shifters. Such an embodiment is described in detail hereinafter with reference to FIG. 6.

FIG. 6 is a schematic block diagram of a display device according to a second embodiment of the present invention.

Referring to FIG. 6, a display device according to a second embodiment of the present invention has nearly the same configuration as the first embodiment except for the TP signal shifting unit and the signal controller 200. A signal controller 200 of the display device according to the second embodiment outputs separate TP signals TP_{B1}-TP_{Bi} for respective blocks B1-Bi including data lines R1-Rn. Accordingly, there is no TP signal shifting unit 500 of the first embodiment of the present invention.

The signal controller 200 separately supplies the IP signals for the blocks B1-Bi to a data driver 400 to make the data driver 400 output data signals for pixels connected to the data lines R1-Rn of the blocks B1-Bi. The TP signals TP_{B1}-TP_{Bi} for the respective blocks B1-Bi outputted from the signal controller 200 have the time difference preferably equal to the delay of gate signals as shown in FIG. 4. Accordingly, since the data signals are applied to the data lines with the time difference substantially equal to the delay of the gate signals like the first embodiment of the present invention, the non-uniform charging of the data signals in the pixels 110 is improved.

The embodiments of the present invention can be applied to all the active matrix type display devices. For example, when a data driver of an LCD applies data voltages to be supplied to pixels through data lines in a staggered manner, liquid crystal of each pixel properly responds to the applied data voltages. Likewise, an E1 display device supplies data voltages for a sufficient time, an EL element of each pixel is supplied with sufficient current to display appropriate grays.

As described above, the embodiments of the present invention solves non-uniformity in charging of data voltages resulted from the delay or the distortion of gate signals applied to gate lines, which is generated by a load of the gate lines and by parasitic capacitances between the gate lines and pixels and becomes severer at farther places from a gate driver. In particular, an LCD subject to an inversion driving can reduce a shading generated by the delayed gate signals, thereby optimizing a gate masking width.

While the present invention has been described in detail with reference to the embodiments, it is to be understood that the invention is not limited to the disclosed embodiments, but, on the contrary, is intended to cover various modifications and equivalent arrangements included within the sprit and scope of the appended claims.

FIG. 6 is a schematic block diagram of a display device according to a second embodiment of the present invention.

Referring to FIG. 6, a display device according to a second embodiment of the present invention has nearly the same configuration as the first embodiment except for the TP signal shifting unit and the signal controller 200. A signal controller 200 of the display device according to the second embodiment outputs separate TP signals TP_{B1}-TP_{Bi} for respective blocks B1-Bi including data lines R1-Rn. Accordingly, there is no TP signal shifting unit 500 of the first embodiment of the present invention.

The signal controller 200 separately supplies the TP signals for the blocks B1-Bi to a data driver 400 to make the data driver 40D output data signals for pixels connected to the data lines R1-Rn of the blocks B1-Bi. The TP signals TP_{B1}-TP_{Bi} for the respective blocks B1-Bi outputted from the signal controller 200 have the time difference preferably equal to the delay of gate signals as shown in FIG. 4. Accordingly, since the data signals are applied to the data lines with the time difference substantially equal to the delay of the gate signals like the first embodiment of the present invention, the non-uniform charging of the data signals in the pixels 110 is improved.

The embodiments of the present invention can be applied to all the active matrix type display devices. For example, when a data driver of an LCD applies data voltages to be supplied to pixels through data lines in a staggered manner, liquid crystal of each pixel properly responds to the applied data voltages. Likewise, an E1 display device supplies data voltages for a sufficient time, an EL element of each pixel is supplied with sufficient current to display appropriate grays.

As described above, the embodiments of the present invention solves non-uniformity in charging of data voltages resulted from the delay or the distortion of gate signals applied to gate lines, which is generated by a load of the gate lines and by parasitic capacitances between the gate lines and pixels and becomes severer at farther places from a gate driver. In particular, an LCD subject to an inversion driving call reduce a shading generated by the delayed gate signals, thereby optimizing a gate masking width.

While the present invention has been described in detail with reference to the embodiments, it is to be understood that the invention is not limited to the disclosed embodiments, but, on the contrary, is intended to cover various modifications and equivalent arrangements included within the sprit and scope of the appended claims.

FIG. 6 is a schematic block diagram of a display device according to a second embodiment of the present invention.

Referring to FIG. 6, a display device according to a second embodiment of the present invention has nearly the same configuration as the first embodiment except for the TP signal shifting unit and the signal controller 200. A signal controller 200 of the display device according to the second embodiment outputs separate TP signals TP_{B1}-TP_{Bi} for respective blocks B1-Bi including data lines R1-Rn. Accordingly, there is no TP signal shifting unit 500 of the first embodiment of the present invention.

The signal controller 200 separately supplies the TP signals for the blocks B1-Bi to a data driver 400 to make the data driver 400 output data signals for pixels connected to the data lines R1-Rn of the blocks B1-Bi. The TP signals TP_{B1}-TP_{Bi} for the respective blocks B1-Bi outputted from the signal controller 200 have the time difference preferably equal to the delay of gate signals as shown in FIG. 4. Accordingly, since the data signals are applied to the data lines with the time difference substantially equal to the delay of the gate signals like the first embodiment of the present invention, the non-uniform charging of the data signals in the pixels 110 is improved.

The embodiments of the present invention can be applied to all the active matrix type display devices. For example, when a data driver of an LCD applies data voltages to be supplied to pixels through data lines in a staggered manner, liquid crystal of each pixel properly responds to the applied data voltages. Likewise, an E1 display device supplies data voltages for a sufficient time, an EL element of each pixel is supplied with sufficient current to display appropriate grays.

As described above, the embodiments of the present invention solves non-uniformity in charging of data voltages resulted from the delay or the distortion of gate signals applied to gate lines, which is generated by a load of the gate lines and by parasitic capacitances between the gate lines and pixels and becomes severer at farther places from a gate driver. In particular, an LCD subject to an inversion driving can reduce a shading generated by the delayed gate signals, thereby optimizing a gate masking width.

While the present invention has been described in detail with reference to the embodiments, it is to be understood that the invention is not limited to the disclosed embodiments, but, on the contrary, is intended to cover various modifications and equivalent arrangements included within the sprit and scope of the appended claims.

1. A display device comprising:
a display panel including a plurality of data lines extending parallel to each other in a column direction, a plurality of gate lines extending parallel to each other in a row direction, and a plurality of pixels arranged in a matrix and receiving gate signals and data signals respectively from the gate lines and the data lines to display images, each pixel including a switching element transmitting the data signals in response to the gate signals;
a gate driver supplying the gate signals to the gate lines; and
a data driver supplying the data signals to the data lines in synchronization with a plurality of first control signals,
wherein the data lines are grouped into a plurality of blocks, each block including at least one of the data lines and the first control signals correspond to the respective blocks and have different timing.

2. The display device of claim 1, further comprising
a signal controller outputting a timing signal for driving the display panel and a second control signal; and
a control signal shifting unit receiving the second control signal and shifting the second control signal in sequence to generating the first control signals.

3. The display device of claim 2, wherein the control signal shifting unit comprises a plurality of shifters for sequentially shifting the second control signal to be transmitted to adjacent shifters.

4. The display device of claim 3, wherein the first control signals comprises the second control signal and outputs of the shifters.

5. The display device of claim 1, further comprising a signal controller outputting a timing signal for driving the display panel and a second control signal.

6. The display device of claim 1, wherein at least one of timing differences between the first control signals is different from another of the tiring differences.

7. A display device comprising:
a display panel including a plurality of data lines extending parallel to each other in a column direction, a plurality of gate lines extending parallel to each other in a row direction, and a plurality of pixels arranged in a matrix and receiving gate signals and data signals respectively from the gate lilies and the data lines to display images, each pixel including a switching element transmitting the data signals in response to the gate signals;
a signal controller outputting first and second control signals for controlling timings of the gate signals and the data signals, respectively;
a gate driver supplying the gate signals to the gate lines in synchronization with the first control signal from the signal controller;
a control signal shifting unit shifting the second control signal in sequence to generate a plurality of third control signals having timing differences; and
a data driver supplying the data signals to a plurality of blocks of the data lines in synchronization with the third control signals from the control signal shifting unit, each block including at least one of the data lines and corresponding to one of the third control signals.

8. The display device of claim 7, wherein the control signal shifting unit comprises a plurality of shifters generating the third control signals by sequentially shifting the second control signal to be transmitted to adjacent one of the shifters.

9. The display device of claim 7, wherein at least one of the timing differences between the third control signals is different from another of the timing differences.

10. A display device comprising:
a display panel including a plurality of data lines extending parallel to each other in a column direction, a plurality of gate lines extending parallel to each other in a row direction, and a plurality of pixels arranged in a matrix and receiving gate signals and data signals respectively from the gate lines and the data lines to display images, each pixel including a switching element transmitting the data signals in response to the gate signals;
a signal controller outputting a first control signal for controlling timing of the gate signals and a plurality of second control signals for controlling timing of the data signals, the second control signals having timing differences;
a gate driver supplying the gate signals to the gate lines in synchronization with the first control signal; and
a data driver supplying the data signals to a plurality of blocks of the data lines in synchronization with the second control signals from the signal controller, each block including at least one of the data lines and corresponding to one of the third control signals.

11. The display device of claim 10, wherein at least one of the timing differences between the second control signals is different from another of the timing differences.
